(19) United States
(12) Patent Application Publication
(10) Pub. No.: US 2021/0291035 A1
(43) Pub. Date: Sep. 23, 2021

(54) WORD-AND-NUMBERS LOGIC GAME

(71) Applicant: Tony Andrew Guarino, Ballston Lake, NY (US)

(72) Inventor: Tony Andrew Guarino, Ballston Lake, NY (US)

(21) Appl. No.: 16/826,293

(22) Filed: Mar. 23, 2020

(51) Int. Cl. A63F 9/00; A63F 13/80; A63F 13/63; A63F 13/67

(52) U.S. Cl. CPC A63F 9/0098; A63F 13/80; A63F 2300/6027; A63F 13/67; A63F 2300/6018; A63F 13/63

(57) ABSTRACT

A logic game that uses words and numbers in combination is taught. In one embodiment, said game comprises two random parent words selected by a game developer (human or computer). Said game developer assigns point values to each letter of said two random parent words. A target word with a unique number of points determined by said parent word points associated with said target word is selected by said game developer. The game shows the total number of letters and the point value in said target word. Parent word letters are used in said target word, each of said letters being used in said target word either zero or one time. The game is solved by adding said points assigned to each letter used in said target word to arrive at a point sum and finished when said point sum is equal to said unique number of points associated with said target word assigned by said game developer.

### BACKGROUND OF THE INVENTION

### 1. Field of the Invention

This invention lies in the field of logic games, specifically logic games that employ both words and numbers, in combination, in their execution.

### 2. Description of Related Art

Many word games exist in the art. Examples include jumbled-letter games, find-a-word games, hangman-type games, and Scrabble®-type games. Word games are popular diversions.

Almost as many math- and numbers-based games exist; Sudoku®-type games, connect-the-dots games, chess, checkers, matching games are examples. Again, math- and numbers-based games are popular diversions.

However, games that combine math and word games are not widespread. An Australian television game show that was broadcast in Australia in the early 20-teens called “Letters and Numbers” played a game wherein contestants played two games: one where they got a random collection of letters and had to create the longest word they can, and one where they got a random collection of numbers and a random target and had to create a calculation that produced the target (https://blogs.adelaide.edu.au/maths-learning/2018/08/13/numbers-and-letters/). A variant of that game allows the contestants to pick their own random numbers or letters. Letters and numbers are not combined into the same game.

### BRIEF DESCRIPTION OF THE DRAWINGS

FIG. 1 shows an example of an unsolved logic game 100 using numerical point values 105 assigned to the letters 110 used in two parent words 115, 120 to form a unique target word 125.

FIG. 2 shows an example of a solved logic game 100 puzzle 215 using numerical point values 105 assigned to the letters 110 used in two parent words 115, 120 to form a unique target word 125.

FIG. 3 shows a flow chart 305 for developing a logic game 100 for use by a game developer (which may be a human 210 or a computer 215) to develop individual puzzles 310 for said logic game 100.

FIG. 4 shows a flow chart 405 for a player's (which may be human 410 or a computer 415) use in solving said logic game's 100 puzzle 215.

### DETAILED DESCRIPTION OF THE INVENTION

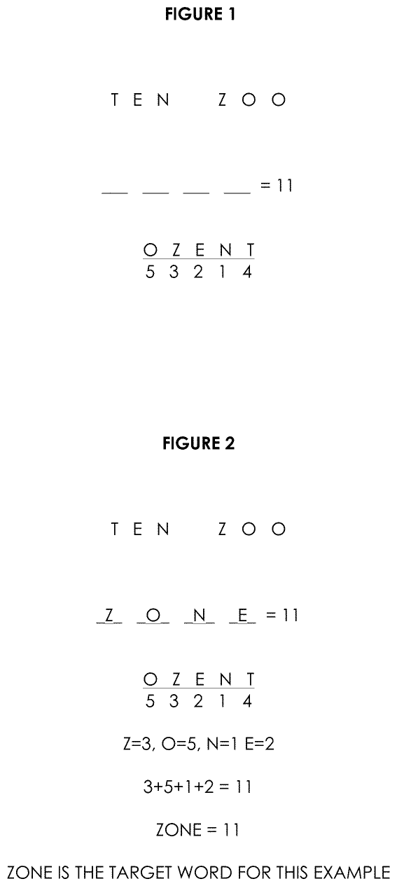

Referring now to FIG. 1, an unsolved logic game 100 using numerical point values 105 assigned to letters 110 that are used in two parent words 115, 120 to form a unique target word 125 is shown. Said target word 125, in the present embodiment, is never equal to one of said two parent words 115 120, although in other embodiments, said target word 125 may be equal one of said two parent words 115, 120, or said target word 125 may be a compound word of the two parent words 115,120. Each letter 110 of each parent word 115, 120 can, but need not, be played. Each of said letters 110 can be played up to one time. At least one letter 110 in said unique target word 125 must come from each of said parent words 115, 120. All letters 110 in said target word 125 must be letters 110 contained in said parent words 115, 120.

Referring now to FIG. 2, an example of a point value 105 for each letter 110 to solve for said target word 125 is shown. Said target word 125 is solved when said point value 105 given for said puzzle solution by a game developer 210, 215, who may be human 210 or a computer 215, is equal to a point value 105 solved for by a player (who can be a human 410 or a computer 415) by adding said number 105 assigned to each letter 110 used in said target word 125.

Said point value 105 is a number chosen by said game developer 210, 215. Said point value 105 must be unique 315 to said target word 125 in a word listing 220 that can be formed from said parent words 115, 120. To determine said point value 105, said game developer 210 may, in one embodiment, run an algorithm (not shown) which takes all letters 110 in said parent words 115, 120 and combines them into said word listing 220 all words those letters can form. Several such algorithms are readily available on the internet, and their programming is not part of the present invention, though their use by said game developer 210, 215 is part of the present invention.

In an alternate embodiment of the invention, said game developer 210, 215 may manually develop said word listing 220.

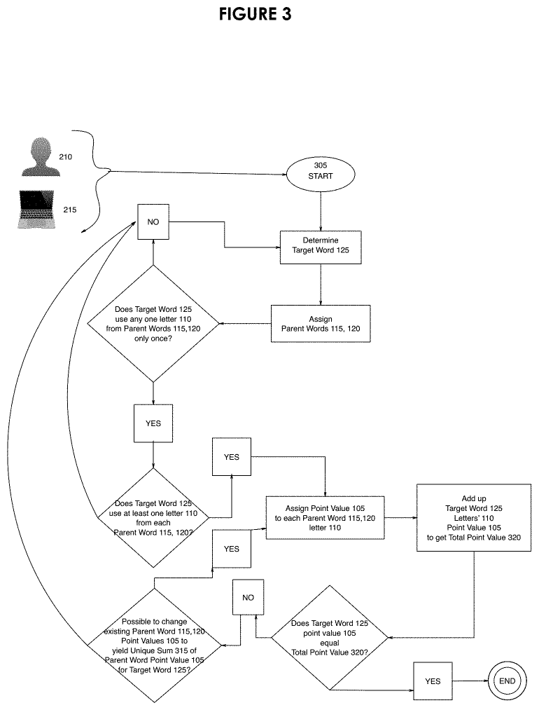

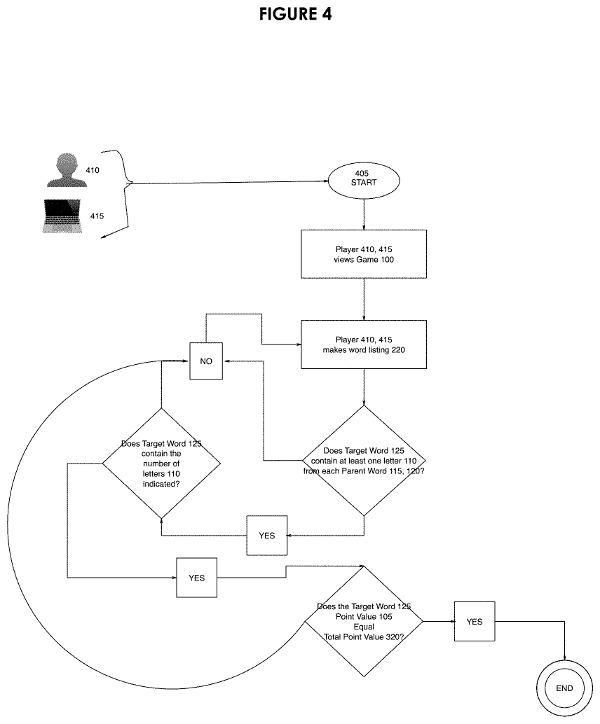

FIG. 3 shows a flow chart 305 for developing a logic game 100 for use by a game developer 210, 215 to develop individual puzzles 310 for said logic game 100.

A game developer 210, 215, in one embodiment, starts developing a word/number logic puzzle 100 by determining a target word 125. Said game developer then assigns at least two parent words 115, 120. In another embodiment, said game developer 210, 215 starts developing a word/number logic puzzle by assigning at least two parent words 115, 120 then determining a target word 125.

Said game developer 210, 215 then determines whether said target word 125 uses any one letter 110 from any parent word 115, 120 only once. If the answer to that determination is no, said game developer 210, 215 returns to assign new parent words 115, 120.

If the answer to that determination is yes, said game developer 210, 215 moves on to determine whether said target word 125 uses at least one letter 110 from each parent word 115, 120. If the answer to that determination is no, said game developer 210, 215 reassigns said parent words 115, 120.

If the answer to that determination is yes, said game developer 210, 215 assigns a point value 105 to each letter 110 in said parent words 115, 120. Said game developer 210, 215 then adds the point values 105 represented by the letters 110 in the target word 125 to get a total point value 320. The game developer 210, 215 determines whether said target word 125 point value equals a unique sum 315 of said parent word 115, 120 letter 110 point values 105. If the answer to that determination is yes, said game developer 210, 215 publishes said puzzle 100 and the development process ends.

If the answer to that determination is no, said game developer 210, 215 determines whether changing said existing parent word 115, 120 point values 105 yields a unique sum 315 of said parent word 115, 120 point value 105 for said target word 125. If the answer to that determination is yes, said game developer 210, 215 reassigns point value 105 to each letter 110 of each parent word 115, 120 and repeats the process from that point.

If the answer to that determination is no, said game developer 210, 215 reassigns new parent words 115, 120 and repeats the process from that point.

Referring now to FIG. 4, a flow chart 405 is shown for a player's (human 410 or computer 415) use in solving said logic game 100. Said game developer 210, 215 discloses said parent words 115, 120, the number of said letters 110 in said target word 125, and said point value 105 of said target word 125 to said player 410, 415. Said player 410, 415 wins said game 100 when said point value 105 of said letters 110 used to form said target word 125 equals said point value 105 disclosed by said game developer 210, 215.

Following said flow chart 405, said player 410, 415 views the logic game 100 provided by said game developer 210, 215. Said player sees two parent words 115, 120, a set number of letter spaces 420 for said target word 125, a point value 105 for said target word, and the letters 110 from said parent words 210, 215 with point values 105 assigned.

Said player 410, 415 brainstorms a list of words that may be formed by combining letters 110, one of which must be taken from each parent word 210, 215.

Going through the list of possible target words 125 the brainstorming session produces, said player 410, 415 determines whether the target word has as least one letter 110 from each parent word 210, 215. If that determination is no, said player 410, 415 returns to brainstorm further possible target words 125.

If that determination is yes, said player 410, 415 determines whether said target word 125 contains the number of letters 110 indicated by said game developer 210, 215. If that determination is no, said player 410, 415 returns to brainstorm further possible target words 125.

If that determination is yes, said player 410, 415 then determines whether said point value 105 of said target word 125 equals said point value 105 given for the solution 430 to the puzzle. If the determination is yes, said player has won the game.

If said determination is no, said player 410, 415 returns to brainstorm further possible target words 125.

Said game 100 may be formatted as an electronic gaming application 105 for play on a tablet 435, smartphone 440, laptop 445 or desktop computer 450 that uses any known operating system. Alternatively, said game may comprise a puzzle printed on any substrate which said player uses a writing instrument such as a pen 455 or pencil 460 to solve, though any writing instrument may be used; further examples, none of which are pictured, in this non-exclusive listing include chalk, crayon, stylus, brush and marker.

In another embodiment of the invention, more than two parent words may be used to form said target word.

In another embodiment of the invention, only one parent word may be used to form said target word.

In another embodiment of the invention, there may be more than one target words.

In another embodiment of the invention, the target word may be one of the parent words.

In another embodiment, the target word may be a compound word comprised of all of both parent words.

In another embodiment of the invention, there may be more than one player 410, 415, one or more of which may be human and one or more of which may be a machine.

The embodiments provided here are examples only and are not intended to be a complete listing of possible embodiments, nor should they be construed as an exclusive listing of embodiments. Variations in the described invention and its uses are possible within the scope of this disclosure without departing from the subject matter coming within the scope of claims to be examined, and a reasonable equivalency thereof, which I regard as my invention.

I claim:

1. A logic game that uses words and numbers in combination, said game comprising:
A game developer and at least one player;
Two random parent words selected by said game developer;
Assignment of points by said game developer to each letter of said two random parent words;
A target word where said target word uses at least one letter from each parent word, said target word being selected by said game developer;
A point sum associated with said target word, said point sum being the sum of the points assigned to the corresponding letter in said parent words by said game developer and shown to said player;
A total number of letters in said target word being shown in said logic game by said game developer to said player;
Use by said player of parent word letters in said target word, each of said letters being used in said target word either zero or one time;
Use by said player of at least one letter from each parent word in said target word;
Said player adding said points assigned to each letter used in said target word to arrive at a point sum; and
Said player completing said logic game by completing said target word such that said point sum is equal to said unique number of points associated with said target word assigned by said game developer.

2. The logic game of claim 1, further comprising said logic game playing method being chosen from a member of the group consisting of paper with a writing implement and an electronic application.

3. The logic game of claim 2 further comprising an application hosting device for said electronic application being chosen from a member of the group consisting of smartphone, tablet, laptop, and desktop computer.

4. The logic game of claim 1 further comprising said game developer being chosen from a member of the group consisting of a human being and a computer program.

5. The logic game of claim 1 further comprising said player being chosen from a member of the group consisting of a human being and a computer program.

6. A logic game that uses words and numbers in combination, said game comprising:
A game developer, said game developer being chosen from a member of the group consisting of a human being and a computer program, and at least one player, said player being chosen from a member of the group consisting of a human being and a computer program;
Two random parent words selected by said game developer;
Assignment of points to each letter of said two random parent words by said game developer;
A target word with a unique number of points associated with said target word, said unique number of points being selected by said game developer;
A total number of letters in said target word being shown in said logic game by said game developer to said player;
Use by said player of parent word letters in said target word, each of said letters being used in said target word either zero or one time;
Said player adding said points assigned to each letter used in said target word to arrive at a point sum; and
Said player completing said logic game by completing said target word such that said point sum is equal to said unique number of points associated with said target word assigned by said game developer.

7. The logic game of claim 5, further comprising said logic game playing method being chosen from a member of the group consisting of paper with a writing implement and an electronic application.

8. The logic game of claim 6 further comprising an application hosting device being chosen from a member of the group consisting of smartphone, tablet and personal computer.

9. A logic game that uses words and numbers in combination, said game comprising:
A game developer, said game developer being chosen from a member of the group consisting of a human being and a computer program, and at least one player, said player being chosen from a member of the group consisting of a human being and a computer program;
Two random parent words selected by said game developer;
Assignment of points to each letter of said two random parent words by said game developer;
A target word with a unique number of points associated with said target word, said unique number of points being selected by said game developer;
A total number of letters in said target word being shown in said logic game by said game developer to said player;
Use by said player of parent word letters in said target word, each of said letters being used in said target word either zero or one time;
Said logic game playing method being chosen from a member of the group consisting of writing substrate with a writing implement and an electronic application, said electronic application residing on a device chosen from the group consisting of smartphone, tablet, laptop, and desktop computer;
Said player adding said points assigned by said game developer to each letter used in said target word to arrive at a point sum; and
Said player completing said logic game by completing said target word such that said point sum is equal to said unique number of points associated with said target word assigned by said game developer.
